(19) United States
(12) Patent Application Publication
(10) Pub. No.: US 2025/0086429 A1
(43) Pub. Date: Mar. 13, 2025

(54) METHOD AND SYSTEM FOR PREDICTING TARGET DESCRIPTOR VALUE OF TARGET OBJECT

(71) Applicant: Beijing Real Material Data Technology Development Co., Ltd., Beijing (CN)

(72) Inventors: Xiaodong XIANG, Danville, CA (US); Shaomeng XU, Kunming (CN)

(73) Assignee: Beijing Real Material Data Technology Development Co., Ltd., Beijing (CN)

(21) Appl. No.: 18/955,760

(22) Filed: Nov. 21, 2024

Related U.S. Application Data
(60) Provisional application No. 63/426,814, filed on Nov. 21, 2022.

(30) Foreign Application Priority Data
Nov. 21, 2023 (CN) 202311562056.1

(51) Int. Cl. G06N 3/045

(52) U.S. Cl. CPC G06N 3/045

(57) ABSTRACT

A method and system for predicting a target descriptor value of a target object is provided, including: obtaining N pieces of attribute information for describing the target object; and running an adversarial neural network to obtain a target predicted value corresponding to a target descriptor of the target object, where the adversarial neural network is a network with i layers connected in sequence, each layer of the adversarial neural network includes a first-level regression neural network and a second-level regression neural network connected in sequence.

### RELATED APPLICATIONS

This application claims the benefit of priority of Chinese application number 2023115620561, filed on Nov. 21, 2023, which claims the benefit of priority of U.S. provisional application No. 63/426,814, filed on Nov. 21, 2022, and the contents of the foregoing documents are incorporated herein by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of artificial intelligence technology, and in particular to a method and system for predicting a target descriptor value of a target object.

### BACKGROUND

In the related technology, a training system can train a neural network model, and a prediction system can predict the target descriptor values of a target object based on the neural network model. For example, when the prediction system obtains input information, it can input the information into a pre-trained neural network model, where the output of the neural network model corresponds to the target descriptor values of the target object.

However, the inventors of this disclosure have found that when the prediction system uses the above method to predict the target descriptor values, the accuracy of the predicted values based on the neural network model is low due to the suboptimal inference performance of the neural network model.

The content in the background section is only information known to the inventors and does not represent that such information had entered the public domain prior to the filing date of this disclosure, nor does it represent that it can be considered prior art of this disclosure.

### SUMMARY

This disclosure provides a method and system for predicting a target descriptor value(s) of a target object to improve the accuracy of the predictions.

In a first aspect, the present disclosure provides a method for predicting a target descriptor value of a target object, including: obtaining input information of a trained adversarial neural network, wherein the input information includes N pieces of attribute information to describe the target object, and N is an integer greater than 1; and running the adversarial neural network to obtain a target predicted value corresponding to a target descriptor of the target object, where the adversarial neural network is an adversarial neural network with i layers, each layer of the adversarial neural network includes a first-level regression neural network and a second-level regression neural network connected in sequence, and i is an integer greater than or equal to 1, an input of a first-level regression neural network at a first layer of the adversarial neural network is the N pieces of attribute information, and an output of a second-level regression neural network at an i^{th} layer of the adversarial neural network is the target predicted value corresponding to the target descriptor of the target object, an output of the first-level regression neural network at each layer of the adversarial neural network is an intermediate predicted value corresponding to the target descriptor, an input of each of a first-level regression neural network at a second layer of the adversarial neural network to a first-level regression neural network at the i^{th} layer of the adversarial neural network is an output of a second-level regression neural network at a previous layer of the adversarial neural network, an input of a second-level regression neural network at the first layer of the adversarial neural network includes the N pieces of attribute information and an intermediate predicted value output by the first-level regression neural network at the first layer of the adversarial neural network, and an input of each of a second-level regression neural network at the second layer of the adversarial neural network to the second-level regression neural network at the i^{th} layer of the adversarial neural network includes an intermediate predicted value output by a first-level regression neural network at a corresponding layer and the output of the second-level regression neural network at the previous layer of the adversarial neural network.

In a second aspect, the present disclosure provides a system for predicting a target descriptor value of a target object, including: at least one storage medium storing at least one set of instructions; and at least one processor in communication with the at least one storage medium, wherein during operation, the at least one processor executes the at least one set of instructions to cause the system to at least: obtain input information of a trained adversarial neural network, wherein the input information includes N pieces of attribute information to describe the target object, and N is an integer greater than 1, and run the adversarial neural network to obtain a target predicted value corresponding to a target descriptor of the target object, wherein the adversarial neural network is an adversarial neural network with i layers, each layer of the adversarial neural network includes a first-level regression neural network and a second-level regression neural network connected in sequence, and i is an integer greater than or equal to 1, an input of a first-level regression neural network at a first layer of the adversarial neural network is the N pieces of attribute information, and an output of a second-level regression neural network at an i^{th} layer of the adversarial neural network is the target predicted value corresponding to the target descriptor of the target object, an output of the first-level regression neural network at each layer of the adversarial neural network is an intermediate predicted value corresponding to the target descriptor, an input of each of a first-level regression neural network at a second layer of the adversarial neural network to a first-level regression neural network at the i^{th} layer of the adversarial neural network is an output of a second-level regression neural network at a previous layer of the adversarial neural network, an input of a second-level regression neural network at the first layer of the adversarial neural network includes the N pieces of attribute information and an intermediate predicted value output by the first-level regression neural network at the first layer of the adversarial neural network, and an input of each of a second-level regression neural network at the second layer of the adversarial neural network to the second-level regression neural network at the i^{th} layer of the adversarial neural network includes an intermediate predicted value output by a first-level regression neural network at a corresponding layer and the output of the second-level regression neural network at the previous layer of the adversarial neural network.

The present disclosure provides a method and system for predicting a target descriptor value of a target object, including: obtaining input information of a trained adversarial neural network, where the input information is N pieces of attribute information used to describe the target object, and N is an integer greater than 1; and running the adversarial neural network to obtain a target predicted value corresponding to a target descriptor of the target object, where the adversarial neural network is an adversarial neural network with i layers, each layer of the adversarial neural network includes a first-level regression neural network and a second-level regression neural network connected in sequence, and i is an integer greater than or equal to 1; an input of a first-level regression neural network at a first layer of the adversarial neural network is the N pieces of attribute information, and an output of a second-level regression neural network at an i^{th} layer of the adversarial neural network is the target predicted value corresponding to the target descriptor of the target object; an output of the first-level regression neural network at each layer of the adversarial neural network is an intermediate predicted value corresponding to the target descriptor; an input of each of a first-level regression neural network at a second layer of the adversarial neural network to a first-level regression neural network at the i^{th} layer of the adversarial neural network is an output of a second-level regression neural network at a previous layer of the adversarial neural network; an input of a second-level regression neural network at the first layer of the adversarial neural network includes the N pieces of attribute information and an intermediate predicted value output by the first-level regression neural network at the first layer of the adversarial neural network; and an input of each of a second-level regression neural network at the second layer of the adversarial neural network to the second-level regression neural network at the i^{th} layer of the adversarial neural network includes an intermediate predicted value output by a first-level regression neural network at the corresponding layer and the output of the second-level regression neural network at the previous layer of the adversarial neural network. Herein, the adversarial neural network has a multi-layer structure, and each layer of the adversarial neural network includes the first-level regression neural network and the second-level regression neural network connected in sequence. For different layers of the adversarial neural network, an output of a previous layer of the adversarial neural network is used as an input of its next layer of the adversarial neural network. For a same layer of the adversarial neural network, an output of a first-level regression neural network at the same layer of the adversarial neural network is used as a partial input of a second-level regression neural network at the same layer of the adversarial neural network, so that adversaries are implemented by using logic of the foregoing different layers and the same layer, and that the target predicted value corresponding to the target descriptor is obtained, to improve effectiveness and reliability of the prediction.

### BRIEF DESCRIPTION OF THE DRAWINGS

The accompanying drawings herein are incorporated into the specification and constitute a part of the specification. The accompanying drawings show embodiments in accordance with the present disclosure and are used together with the specification to explain the principle of the present disclosure.

FIG. 1 is a schematic diagram of a structure of an ANN according to some exemplary embodiments of the present disclosure;

FIG. 2 is a schematic diagram of a structure of a CNN according to some exemplary embodiments of the present disclosure;

FIG. 3 is a schematic diagram of an application scenario of a method for predicting a target descriptor value of a target object according to some exemplary embodiments of the present disclosure;

FIG. 4 is a schematic diagram of a method for predicting a target descriptor value of a target object according to some exemplary embodiments of the present disclosure;

FIG. 5 is a schematic diagram of an adversarial neural network according to some exemplary embodiments of the present disclosure;

FIG. 6 is a schematic diagram of an adversarial neural network according to another embodiment of the present disclosure; and

FIG. 7 is a diagram of a hardware structure of an electronic device according to some exemplary embodiments of the present disclosure.

Embodiments of the present disclosure have been illustrated clearly in the foregoing drawings, and will be described in more detail hereinafter. These drawings and text descriptions are not intended to limit the scope of the present disclosure in any manner, but to illustrate the concept of the present disclosure to a person skilled in the art by referring to specific embodiments.

### DETAILED DESCRIPTION

Exemplary embodiments will be described in detail herein, with examples illustrated in the accompanying drawings. In the following description, when referring to the drawings, the same numbers in different drawings indicate the same or similar elements, unless otherwise noted. The embodiments described in the following exemplary embodiments do not represent all possible embodiments consistent with this disclosure. Instead, they are merely examples of devices and methods consistent with some aspects of the present disclosure as detailed in the appended claims.

It should be understood that in the embodiments of this disclosure, the terms “comprising” and “having,” as well as any variations thereof, are intended to cover inclusive but not exclusive inclusion. For example, a product or device that includes a series of components is not necessarily limited to those components explicitly listed, but may include other components not explicitly listed or components inherent to those products or devices.

In the embodiments of this disclosure, the term “and/or” describes an associative relationship between associated objects, indicating three possible relationships. For example, “A and/or B” can represent: A alone, both A and B, or B alone. The character “/” generally indicates an “or” relationship between the associated objects.

The term “multiple” in this disclosure refers to two or more, and other quantifiers are used in a similar manner.

The terms “first,” “second,” “third,” and so on are used to distinguish similar or related objects or entities and do not necessarily imply a specific order or sequence, unless otherwise indicated. It should be understood that these terms can be used interchangeably where appropriate, for example, in a sequence other than that illustrated or described in the embodiments of this disclosure.

The terms “unit/module” used in this disclosure refer to any known or later-developed hardware, software, firmware, artificial intelligence, fuzzy logic, or a combination of hardware and/or software code capable of performing functions associated with that element.

To help a reader understand the present disclosure, at least some of the terms used in the present disclosure are described as follows:

A descriptor is information describing a target object. For example, in a case where the target object is a target material, the descriptor may be information for describing properties of the target material, such as information for describing conductivity of the target material; in a case where the target object is a target speech, the descriptor may be an intent and/or volume or the like for describing the target speech; in a case where the target object is a target text, the descriptor may be characters or the like for describing the target text; or in a case where the target object is a target image, the descriptor may be a texture feature, a color feature, a pixel feature, a position feature, or the like for describing the target image.

A target descriptor value is a predicted value corresponding to a target descriptor. For example, in a case where the target object is a target material, the target descriptor value may be understood as a predicted value for predicting performance of the target material. For example, the predicted value may be conductivity or the like, which is not exhaustively illustrated herein.

A neural network (Neural Network, NN) is a complex network system formed by a large quantity of simple processing units (which may also be referred to as neurons) that are widely interconnected. It reflects many basic characteristics of human brain functions and is a highly complex nonlinear dynamic learning system. Neural networks include an artificial neural network (Artificial Neural Network, ANN) and a convolutional neural network (Convolutional Neural Network, CNN).

The ANN refers to a complex network structure formed by a large quantity of interconnected neurons. The ANN is a kind of abstraction, simplification, and simulation of an organizational structure and operation mechanism of a human brain. The ANN may be classified into a multi-layer ANN and a single-layer ANN. Each layer includes several neurons. The neurons are connected by directed arcs with variable weights. The network repeatedly learns and trains known information and gradually adjusts and changes weights of neuron connections to achieve an objective of processing information and simulating an input-output relationship.

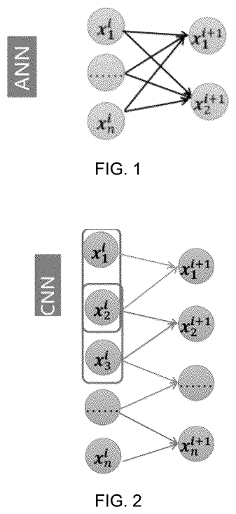

With reference to FIG. 1, it can be learned that neurons at each layer in the ANN are all connected to neurons at a previous layer. For example, as shown in FIG. 1, both x₁ⁱ⁺¹ and x₂ⁱ⁺¹ at an (i+1)^{th} layer are respectively connected to each of neurons x₁ⁱ to xₙⁱ at an i^{th} layer, where both i and n are integers greater than 0. Therefore, the ANN may also be referred to as a fully connected neural network.

Correspondingly, in a case where i is 1, if the target object is a target material, x is a descriptor of the target material, for example, may be specifically an element of the target material. In this case, a first layer is an input layer of the ANN. Because the ANN is a fully connected neural network, when the ANN is used as a network framework for model training, many parameters need to be optimized.

The CNN is a type of feedforward neural network (Feedforward Neural Network) that includes convolutional computing and has a deep structure. It is one of representative algorithms for deep learning (deep learning). The CNN is capable of representation learning (representation learning) and capable of performing shift-invariant classification (shift-invariant classification) on input information based on a hierarchical structure of the CNN. Therefore, the CNN is also referred to as a “shift-invariant artificial neural network (Shift-Invariant Artificial Neural Network, SIANN)”.

With reference to FIG. 2, it can be learned that neurons in the CNN have clear division of roles. A neuron at a next layer is locally connected to a neuron at a previous layer. As shown in FIG. 2, a neuron x₁ⁱ⁺¹ at an (i+1)^{th} layer is connected to neurons x₁ⁱ and x₂ⁱ at an i^{th} layer, a neuron x₁ⁱ⁺² at the (i+1)^{th} layer is connected to neurons x₂ⁱ and x₃ⁱ at the i^{th} layer, . . . , a neuron xₙⁱ⁺¹ at the (i+1)^{th} layer is connected to neurons xₙⁱ and xₙ₋₁ⁱ at the i^{th} layer (not shown in the figure).

Correspondingly, compared with model training using the ANN as a network framework, when model training is performed by using the CNN as a network framework, since weights are shared between neurons at each layer of the CNN, parameters that need to be optimized are reduced in comparison with those in the ANN.

In the related art, a prediction system may predict a target descriptor value based on a pre-trained neural network model, and the neural network model may be obtained by the prediction system through training or by other systems (such as a training system) through training. This is not limited herein.

For example, using the neural network model obtained by the training system through training as an example, the pre-trained neural network model is obtained by the training system through training based on sample data, and the sample data may be a sample descriptor. In other words, at a training stage of the neural network model, the training system may input the sample descriptor into an initial network model for single-level inference (the ANN or the CNN) to predict the sample data based on the initial network model, and output a prediction result (that is, a predicted target descriptor value). The prediction system compares the prediction result with a pre-marked real result (that is, a real target descriptor value) to obtain a comparison result, and iteratively updates parameters of the initial network model based on the comparison result, thereby obtaining a trained neural network model.

Correspondingly, the training system may transmit the trained neural network model to the prediction system, or the prediction system may invoke the trained neural network model from the training system in presence of a prediction requirement, to perform prediction based on the trained neural network model. For example, at an application stage, the prediction system inputs prediction data that needs to be predicted into the trained neural network model and outputs the prediction result.

It should be noted that content of the related art is only information known to the inventor personally, and neither represents that the information has entered the public domain before the filing date of the present disclosure, nor represents that it can become the prior art of the present disclosure.

The present disclosure provides a technical conception obtained through creative labor: A prediction system runs an adversarial neural network to predict a target predicted value (that is, a target descriptor value) corresponding to a target descriptor by using the adversarial neural network and obtain the target predicted value. A structure of the adversarial neural network is a multi-layer structure, and each layer of the adversarial neural network includes two levels of regression neural networks connected in sequence. Correspondingly, an input of a first-level regression neural network at a first layer of the adversarial neural network is input information obtained by the prediction system (such as attribute information of a target object), an input of a second-level regression neural network at the first layer of the adversarial neural network is an output of the first-level neural network at the first layer of the adversarial neural network and the input information obtained by the prediction system, an input of a first-level regression neural network at another layer of the adversarial neural network is an output of a previous layer of the adversarial neural network (specifically, a second-level regression neural network at the previous layer of the adversarial neural network), an input of a second-level regression neural network at the other layer of the adversarial neural network is the output of the previous layer of the adversarial neural network (specifically, the second-level regression neural network at the previous layer of the adversarial neural network) and an output of the first-level regression neural network at this layer, and an output of a last layer of the adversarial neural network (specifically, a second-level regression neural network at the last layer of the adversarial neural network) is the target predicted value.

Before an implementation principle of a method for predicting a target descriptor value of a target object in the present disclosure is described, an application scenario of the method for predicting a target descriptor value of a target object in the present disclosure is first described exemplarily to deepen the reader's understanding of the method for predicting a target descriptor value of a target object in the present disclosure.

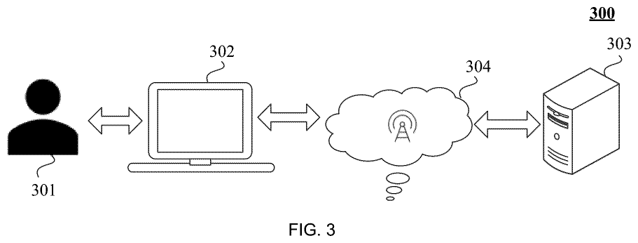

FIG. 3 is a schematic diagram of the application scenario of a method for predicting a target descriptor value of a target object according to some exemplary embodiments of the present disclosure. The method for predicting a target descriptor value of a target object in the present disclosure may be applied to a system 300 for predicting a target descriptor value of a target object as shown in FIG. 3. As shown in FIG. 3, the system 300 may include a target user 301, a client 302, a server 303, and a network 304.

The target user 301 may be a user that triggers the system 300 to predict the target descriptor value of the target object.

The client 302 may be a device that responds to a prediction requirement of the target user 302. In other words, the method for predicting a target descriptor value of a target object may be performed on the client 302. In this case, the client 302 may store data or instructions for performing the method for predicting a target descriptor value of a target object as described in this disclosure, and may execute or may be configured to execute the data or instructions. In some exemplary embodiments, the client 302 may include a hardware device with a data information processing function and a necessary program required to drive the hardware device to work.

As shown in FIG. 3, the client 302 may be communicatively connected to the server 303. The server 303 may be communicatively connected to one client 302, or may be communicatively connected to a plurality of clients 302. In some exemplary embodiments, the client 302 may interact with the server 303 through the network 304 to receive or send messages or the like.

In some exemplary embodiments, the client 302 may include a mobile device, a tablet computer, a notebook computer, an on-board device of a vehicle, or the like, or any combination thereof. In some exemplary embodiments, the mobile device may include a smart home device, a smart mobile device, a virtual reality device, an augmented reality device, or the like, or any combination thereof. In some exemplary embodiments, the smart home device may include a smart television, a desktop computer, or the like, or any combination thereof. In some exemplary embodiments, the smart mobile device may include a smartphone, a personal digital assistant, a game console, a navigation device, or the like, or any combination thereof. In some exemplary embodiments, the built-in device in the motor vehicle may include a vehicle-mounted computer, a vehicle-mounted television, or the like.

In some exemplary embodiments, one or more applications (Application, APP) may be mounted on the client 302. The APP can provide the target user 301 with an ability and an interface to interact with the outside world through the network 304. The APP includes but is not limited to a web browser APP program, a search APP program, a chat APP program, a shopping APP program, a video APP program, a financial management APP program, an instant messaging tool, an e-mail client, a social platform software, or the like.

The server 303 may be a server that provides various services, such as a backend server that provides support for user data sets and account login information corresponding to a plurality of accounts collected on the client 302, and text retrieval of the plurality of accounts.

In some exemplary embodiments, the method for predicting a target descriptor value of a target object may be performed on the server 303. In this case, the server 303 may store data or instructions for performing the method for predicting a target descriptor value of a target object as described in this disclosure, and may execute or may be configured to execute the data or instructions.

In some exemplary embodiments, the server 303 may include a hardware device with a data information processing function and a necessary program required to drive the hardware device to work. Similarly, the server 303 may be communicatively connected to one client 303, and receive data sent by the client 303, or may be communicatively connected to a plurality of clients 303, and receive data sent by each client 303.

The network 304 is a medium for providing a communication connection between the client 302 and the server 303. The network 304 can facilitate exchange of information or data. As shown in FIG. 3, the client 302 and the server 303 may be connected to the network 304 respectively, and transmit information or data to each other through the network 304.

In some exemplary embodiments, the network 304 may be any type of wired or wireless network, or a combination thereof. For example, the network 304 may include a cable network, a wired network, an optical fiber network, a telecommunication network, an intranet, the Internet, a local area network (Local Area Network, LAN), a wide area network (Wide Area Network, WAN), a wireless local area network (Wireless Local Area Network, WLAN), a metropolitan area network (Metropolitan Area Network, MAN), a public switched telephone network (Public Switched Telephone Network, PSTN), a Bluetooth network™, a short-range wireless network (ZigBee™), a near field communication (Near Field Communication, NFC) network, or a similar network.

In some exemplary embodiments, the network 304 may include one or more network access points. For example, the network 304 may include a wired or wireless network access point, such as a base station or an Internet exchange point, through which one or more components of the client 302 and the server 303 may connect to the network 304 to exchange data or information.

It should be understood that quantities of clients 302, servers 303, and networks 304 in FIG. 3 are merely illustrative. Depending on implementation requirements, there may be any quantities of clients 302, servers 303, and networks 304. In addition, the method for predicting a target descriptor value of a target object according to the present disclosure may be performed entirely on the client 302, or may be performed entirely on the server 303, or may be performed partially on the client 302 and partially on the server 303.

In other words, FIG. 3 and the foregoing description of FIG. 3 are only used to exemplarily describe application scenarios to which the method for predicting a target descriptor value of a target object in the present disclosure may be applicable, and cannot be understood as a limitation on the application scenarios.

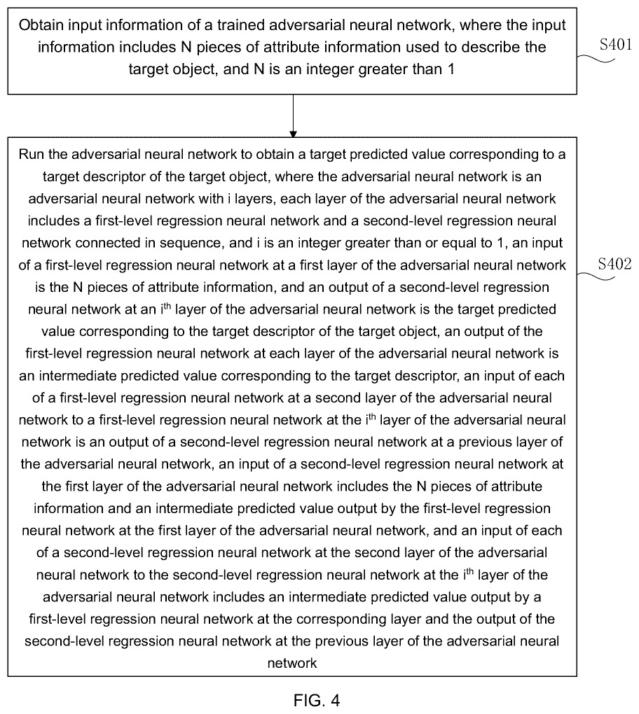

FIG. 4 is a schematic diagram of a method for predicting a target descriptor value of a target object according to some exemplary embodiments of the present disclosure. As shown in FIG. 4, the method includes the following steps.

S401: Obtain input information of a trained adversarial neural network, where the input information includes N pieces of attribute information used to describe the target object, and N is an integer greater than 1.

Exemplarily, this embodiment may be performed by a system for predicting a target descriptor value of a target object (hereinafter referred to as a prediction system). The prediction system may be a server (such as a cloud server or a local server), a terminal device, a processor, a chip, or the like, which is not limited herein.

For example, when the method for predicting a target descriptor value of a target object in this embodiment is applied to the application scenario shown in FIG. 3, it can be learned from FIG. 3 and the foregoing description of FIG. 3 that the prediction system may be the client 302 shown in FIG. 3, or the server 303 shown in FIG. 3, or a combination of the client 302 and the server 303 shown in FIG. 3.

A manner of obtaining input information by the prediction system is not limited herein.

In an example, the prediction system may be connected to other systems and receive input information sent by the other systems.

Exemplarily, using the application scenario shown in FIG. 3 as an example, the prediction system may be the server 303 shown in FIG. 3, and the other systems may be the client 302 shown in FIG. 3. The user 301 may input corresponding input information on the client 302 by using an APP or by non-APP means to trigger the client 302 to send the input information to the server 303.

In another example, the prediction system may provide a tool for loading input information, and the user may transmit input information to the prediction system through the tool for loading input information.

The tool for loading input information may be an interface for connecting to an external device, for example, an interface for connecting to another storage device, where input information transmitted by the external device is obtained through the interface. Alternatively, the tool for loading input information may be a display device. For example, the prediction system may output, on the display device, a function interface for loading input information, the user may import the input information into the prediction system through the interface, and the prediction system obtains the imported input information.

The attribute information is information used to describe the target object. For example, the attribute information may be used to represent a feature of the target object. Content of the attribute information may be different for different target objects.

Exemplarily, with reference to the foregoing analysis, it can be learned that the method of this embodiment of the present disclosure may be applied to different application scenarios, and that the target object and attribute information may be different for different application scenarios. For example, in a case where the application scenario of the method of this embodiment of the present disclosure is a scenario in which a target predicted value of a material is predicted, the target object may be a target material, and the attribute information may be a descriptor of the target material to represent a plurality of elemental properties and/or physical characteristics of the target material.

S402: Run the adversarial neural network to obtain a target predicted value corresponding to a target descriptor of the target object.

The adversarial neural network is an adversarial neural network with i layers, each layer of the adversarial neural network includes a first-level regression neural network and a second-level regression neural network connected in sequence, and i is an integer greater than or equal to 1.

An input of a first-level regression neural network at a first layer of the adversarial neural network is the N pieces of attribute information, and an output of a second-level regression neural network at an i^{th} layer of the adversarial neural network is the target predicted value corresponding to the target descriptor of the target object.

An output of the first-level regression neural network at each layer of the adversarial neural network is an intermediate predicted value corresponding to the target descriptor.

An input of each of a first-level regression neural network at a second layer of the adversarial neural network to a first-level regression neural network at the i^{th} layer of the adversarial neural network is an output of a second-level regression neural network at a previous layer of the adversarial neural network.

An input of a second-level regression neural network at the first layer of the adversarial neural network includes the N pieces of attribute information and an intermediate predicted value output by the first-level regression neural network at the first layer of the adversarial neural network.

An input of each of a second-level regression neural network at the second layer of the adversarial neural network to the second-level regression neural network at the i^{th} layer of the adversarial neural network includes an intermediate predicted value output by a first-level regression neural network at the corresponding layer and the output of the second-level regression neural network at the previous layer of the adversarial neural network.

Exemplarily, the adversarial neural network may have a single-layer network structure or a multi-layer network structure. For example, in a case where i is 1, the adversarial neural network has a single-layer network structure; or in a case where i is an integer greater than 1, the adversarial neural network has a multi-layer network structure. This embodiment is exemplarily described by using the adversarial neural network with a multi-layer network structure as an example. For an implementation principle of the single-layer network structure of the adversarial neural network, refer to an implementation principle of the multi-layer network structure. Details are not described herein again.

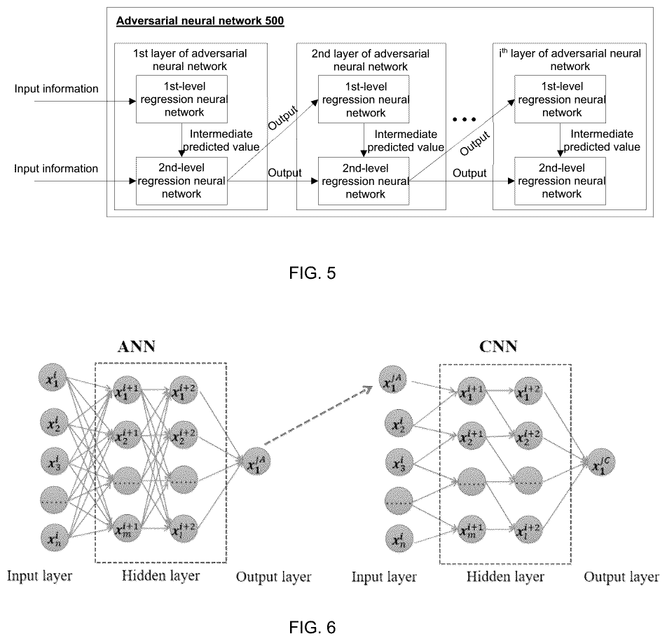

As shown in FIG. 5, an adversarial neural network 500 is an adversarial neural network with i layers, which are respectively marked as a first layer of the adversarial neural network, a second layer of the adversarial neural network, . . . , an i^{th} layer of the adversarial neural network. Each layer of the adversarial neural network includes two levels of regression neural networks, such as a first-level regression neural network and a second-level regression neural network connected in sequence as shown in FIG. 5.

As shown in FIG. 5, using the first layer of the adversarial neural network as an example, an input of a first layer of the adversarial neural network is input information, and specifically, an input of a first-level regression neural network at the first layer of the adversarial neural network is the input information; an output of the first-level regression neural network at the first layer of the adversarial neural network is an intermediate predicted value of the first layer; the intermediate predicted value of the first layer and the input information are an input of a second-level regression neural network at the first layer of the adversarial neural network; and an output of the second-level regression neural network at the first layer of the adversarial neural network is an input of a second layer of the adversarial neural network (specifically a first-level regression neural network at the second layer of the adversarial neural network).

Using the second layer of the adversarial neural network as an example, the input of the second layer of the adversarial neural network is an output of the first layer of the adversarial neural network, and specifically, the input of the first-level regression neural network at the second layer of the adversarial neural network is the output of the second-level regression neural network at the first layer of the adversarial neural network; an output of the first-level regression neural network at the second layer of the adversarial neural network is an intermediate predicted value of the second layer; the intermediate predicted value of the second layer and the output of the second-level regression neural network at the first layer of the adversarial neural network are an input of a second-level regression neural network at the second layer of the adversarial neural network; and an output of the second-level regression neural network at the second layer of the adversarial neural network is an input of a third layer of the adversarial neural network.

By analogy, using an i^{th} layer of the adversarial neural network as an example, an input of the i^{th} layer of the adversarial neural network is an output of an (i−1)^{th} layer of the adversarial neural network, and specifically, an input of a first-level regression neural network at the i^{th} layer of the adversarial neural network is an output of a second-level regression neural network at the (i−1)^{th} layer of the adversarial neural network; an output of the first-level regression neural network at the i^{th} layer of the adversarial neural network is an intermediate predicted value of the (i−1)^{th} layer; an intermediate predicted value of the i^{th} layer and the output of the second-level regression neural network at the (i−1)^{th} layer of the adversarial neural network are an input of a second-level regression neural network at the i^{th} layer of the adversarial neural network; and an output of the second-level regression neural network at the i^{th} layer of the adversarial neural network is a target predicted value.

In other words, for different layers of the adversarial neural network, input information of different layers of the adversarial neural network may be different. For the first layer of adversarial neural network, the input information of the first layer of the adversarial neural network is a descriptor, and for other layers of the adversarial neural network, input information of the other layers of the adversarial neural network is an initial predicted value corresponding to a target descriptor (that is, an output of a previous layer of the adversarial neural network).

With reference to the foregoing example, in a case where the application scenario of the method of this embodiment of the present disclosure is a scenario in which a target predicted value of a material is predicted, the target object may be a target material, and the attribute information may be a plurality of elemental properties and/or physical characteristics or the like of the target material, and the target predicted value may be conductivity or the like.

In other words, in some exemplary embodiments, the prediction system may obtain a descriptor for describing the target material, and input the descriptor into a pre-trained adversarial neural network. The prediction system runs the adversarial neural network, and the adversarial neural network outputs a target predicted value of the target material, such as conductivity.

Types of the first-level regression neural network and the second-level regression neural network are not limited herein. Exemplarily, the first-level regression neural network and the second-level regression neural network may be two different regression neural networks or two identical regression neural networks.

Assuming that the first-level regression neural network and the second-level regression neural network are different regression neural networks, in some exemplary embodiments, the first-level regression neural network may be an ANN, and the second-level regression neural network may be a CNN. Correspondingly, in other embodiments, the first-level regression neural network may be a CNN, and the second-level regression neural network may be an ANN.

In a case where the first-level regression neural network is the ANN, and that the second-level regression neural network is the CNN,
the ANN includes K neuron layers, each neuron layer includes M neurons, and two adjacent neuron layers in the ANN are fully connected; and
the CNN includes P neuron layers, each neuron layer includes Q neurons, and two adjacent neuron layers in the CNN are locally connected based on a preset connection relationship before or during training, where
K, M, P, and Q are all integers greater than 1.

Exemplarily, with reference to the foregoing example and FIG. 1, it can be learned that in the ANN, the ANN includes a plurality of neuron layers, where one neuron layer includes a plurality of neurons, and two adjacent neuron layers are fully connected, that is, each neuron at a previous layer is connected to each neuron at a next layer.

With reference to the foregoing example and FIG. 2, it can be learned that in the CNN, the CNN includes a plurality of neuron layers, where one neuron layer includes a plurality of neurons, two adjacent neuron layers are locally connected, and the local connection may be determined based on a preset connection relationship.

In some exemplary embodiments, in a case where the first-level regression neural network at the first layer of the adversarial neural network is the ANN, and that the second-level regression neural network at the first layer of the adversarial neural network is the CNN,
an input of each neuron at a first neuron layer of the first-level regression neural network at the first layer of the adversarial neural network is the N pieces of attribute information, and an output of a last neuron layer of the ANN is the intermediate predicted value of the first-level regression neural network at the first layer of the adversarial neural network; and
an input of a first neuron layer of the second-level regression neural network at the first layer of the adversarial neural network is determined by grouping the intermediate predicted value of the first-level regression neural network at the first layer of the adversarial neural network and the N pieces of attribute information based on a preset grouping relationship.

Exemplarily, with reference to the foregoing example and FIG. 1, it can be learned that in the ANN, the input of each neuron at the first neuron layer is input information, and that all neurons at the last neuron layer work together to output the intermediate predicted value. Correspondingly, the intermediate predicted value is used as part of the input of the CNN.

In some exemplary embodiments, a quantity of input groups obtained based on the preset grouping relationship is Q, and one neuron at a first neuron layer of the P neuron layers corresponds to one input group; and

Among the Q input groups, an input group of one neuron at the first neuron layer of the CNN includes the intermediate predicted value, and a total count of times that each of the N pieces of attribute information appears in the Q input groups is the same.

With reference to the foregoing example and FIG. 2, it can be learned that in the CNN, the preset grouping relationship is a balanced grouping relationship, that is, a quantity of inputs of neurons in each grouping relationship is the same.

In some exemplary embodiments, N is equal to Q; and attribute information in each of the Q input groups is randomly obtained from the N pieces of attribute information.

In some exemplary embodiments, a first input group of the Q input groups includes the intermediate predicted value and one piece of attribute information, where the first input group is an input group of a first neuron at the first neuron layer of the P neuron layers; and

A quantity of attribute information in other input groups than the first input group among the Q input groups is two pieces.

Exemplarily, with reference to FIG. 6, it can be learned that both the ANN and the CNN include an input layer (input layer), a hidden layer (hidden layer), and an output layer (output layout), and that both the ANN and the CNN include two neuron layers. At the hidden layers of the ANN and the CNN, there are m first neuron layers and l second neuron layers, where m and l are integers greater than 1. At the hidden layers of the ANN and the CNN, all the first neuron layers may be marked as x₁ⁱ⁺¹, x₂ⁱ⁺¹, . . . , xₘⁱ⁺¹, and all the second neuron layers may be marked as x₁ⁱ⁺², x₂ⁱ⁺², . . . xₗⁱ⁺², where i is an integer greater than or equal to 0.

As shown in FIG. 6, the input information of the ANN includes x₁ⁱ, x₂ⁱ, x₃ⁱ, . . . , xₙⁱ, where n is an integer greater than 1. In addition, with reference to the foregoing description of characteristics of the ANN, an input of each neuron of the ANN is a full input. In other words, as shown in FIG. 6, an input of each neuron of x₁ⁱ⁺¹, x₂ⁱ⁺¹, . . . , xₘⁱ⁺¹ includes x₁ⁱ, x₂ⁱ, x₃ⁱ, . . . , xₙⁱ, an input of each neuron at the second neuron layer of the ANN is an output of each neuron at the first neuron layer of the ANN, and an output of the ANN is x₁^{jA}.

Correspondingly, the prediction system may perform adversarial processing based on the output x₁^{jA} of the ANN. In addition, with reference to the foregoing description of characteristics of the CNN, as shown in FIG. 6, in the CNN, an input of x₁ⁱ⁺¹ is x₁^{jA} and x₂ⁱ, an input of x₂ⁱ⁺¹ is x₂ⁱ and x₃ⁱ, an input of x₁ⁱ⁺² is x₁ⁱ⁺¹, an input of x₂ⁱ⁺² is x₁ⁱ⁺¹ and x₂ⁱ⁺¹, and so on. Details are not exhaustively illustrated herein.

As shown in FIG. 6, the prediction system performs adversarial processing based on the ANN and the CNN at a certain level of the neural network, thereby obtaining the output x₁^{JC} of the first layer of the adversarial neural network.

It is worth noting that the above examples are merely illustrative, demonstrating that the prediction system uses the output of the ANN as the input of the CNN for adversarial processing. This should not be construed as a limitation on the adversarial processing of the prediction system. For instance, in another possible technical implementation, the prediction system can use the output of the CNN as the input of the ANN for adversarial processing. The specific implementation principles can refer to the above example and will not be elaborated here.

Based on the above technical concept, this disclosure also provides a system for predicting the target descriptor values of a target object, including:
At least one storage medium, which stores at least one set of instructions; and
At least one processor, in communication with the at least one storage medium.

When the system for predicting the target descriptor values of a target object is running, the at least one processor reads the at least one set of instructions and executes the method for predicting the target descriptor values of the target object as described above, according to the instructions of the at least one set of instructions.

Based on the above technical concept, this disclosure also provides a processor-readable storage medium, which stores a computer program. The computer program is used to enable the processor to execute the method for predicting the target descriptor values of a target object as described above or the method for training the prediction model.

Based on the above technical concept, this disclosure also provides a computer program product, which includes a computer program. When executed by a processor, the computer program implements the method for predicting the target descriptor values of a target object or the method for training the prediction model as described above.

Based on the above technical concept, this disclosure also provides an electronic device, including:
A processor; and
A memory in communication with the processor.

The memory stores computer-executable instructions, and the processor executes the computer-executable instructions stored in the memory to implement the method for predicting the target descriptor values of a target object or the method for training the prediction model as described above.

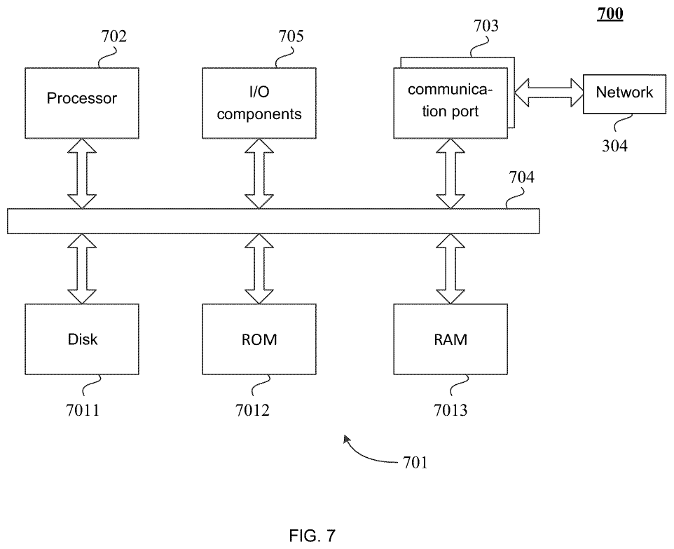

FIG. 7 shows the hardware structure diagram of an electronic device 700 according to some exemplary embodiments of this disclosure. The electronic device 700 can execute the method for predicting the target descriptor values of a target object or the method for training the prediction model as described in any of the above embodiments.

Taking as an example the application of the method for predicting the target descriptor values of a target object or the method for training the prediction model of this disclosure in the application scenario shown in FIG. 3, the description of the electronic device 700 is as follows.

In the case where the method for predicting the target descriptor values of a target object or the method for training the prediction model as described in any of the above embodiments is executed on the client 302, electronic device 700 can be the client 302. In the case where the method for predicting the target descriptor values of a target object or the method for training the prediction model as described in any of the above embodiments is executed on the server 303, the electronic device 700 can be the server 303. In the case where part of the method for predicting the target descriptor values of a target object or the method for training the prediction model as described in any of the above embodiments is executed on the client 302 and part is executed on the server 303, the electronic device 700 can be both the client 302 and the server 303.

As shown in FIG. 7, the electronic device 700 may include at least one storage medium 701 and at least one processor 702. In some exemplary embodiments, electronic device 700 may also include a communication port 703 and an internal communication bus 704. At the same time, electronic device 700 may also include input/output (I/O) components 705.

The internal communication bus 704 can connect different system components, including the storage medium 701, the processor 702, and the communication port 703. The I/O components 705 support input/output between electronic device 700 and other components. Communication port 703 is used for data communication between electronic device 700 and external devices. For example, the communication port 703 can be used for data communication between the electronic device 700 and the network 304. The communication port 703 can be a wired communication port or a wireless communication port.

The storage medium 701 can include a data storage device. This data storage device can be a non-temporary storage medium or a temporary storage medium. For example, the data storage device can include one or more of a disk 7011, Read-Only Memory (ROM) 7012, or Random Access Memory (RAM) 7013. The storage medium 701 also includes at least one set of instructions stored in the data storage device. These instructions are computer program code, which can include programs, routines, objects, components, data structures, processes, modules, etc., for executing the method for predicting the target descriptor values of a target object or the method for training the prediction model as provided in this disclosure.

The at least one processor 702 can be connected to at least one storage medium 701 and communication port 703 via an internal communication bus 704. The at least one processor 702 is used to execute the aforementioned at least one set of instructions. When electronic device 700 is running, the at least one processor 702 reads the at least one set of instructions and, according to the instructions, executes the method for predicting the target descriptor values of a target object or the method for training the prediction model provided in this disclosure. The processor 702 can execute all the steps included in the method for predicting the target descriptor values of a target object or the method for training the prediction model. The processor 702 can be in the form of one or more processors. In some exemplary embodiments, processor 702 can include one or more hardware processors, such as microcontrollers, microprocessors, Reduced Instruction Set Computer (RISC), Application-Specific Integrated Circuits (ASIC), Application-Specific Instruction Processors (ASIP), Central Processing Units (CPU), Graphics Processing Units (GPU), Physics Processing Units (PPU), microcontroller units, Digital Signal Processors (DSP), Field Programmable Gate Arrays (FPGA), Advanced RISC Machines (ARM), Programmable Logic Devices (PLD), or any circuits or processors capable of performing one or more functions, or any combination thereof. For illustrative purposes only, this disclosure describes only one processor 702 in electronic device 700. However, it should be noted that electronic device 700 in this disclosure may also include multiple processors, and therefore, the operations and/or method steps disclosed in this disclosure can be executed as described by a single processor or jointly by multiple processors. For example, if processor 702 of electronic device 700 in this disclosure performs steps A and B, it should be understood that steps A and B can also be executed jointly or separately by two different processors 702 (e.g., the first processor executes step A, the second processor executes step B, or the first and second processors jointly execute steps A and B).

A person skilled in the art will understand that the embodiments of this disclosure can be provided as a method, a system, or a computer program product. Therefore, this disclosure can be implemented as a fully hardware embodiment, a fully software embodiment, or an embodiment combining software and hardware aspects. Moreover, this disclosure can be implemented as a computer program product on one or more computer-usable storage media containing computer-usable program code (including but not limited to disk storage, optical storage, etc.).

This disclosure is described with reference to flowcharts and/or block diagrams of methods, devices (systems), and computer program products according to the embodiments of this disclosure. It should be understood that each flow and/or block in the flowcharts and/or block diagrams, and the combinations of flows and/or blocks in the flowcharts and/or block diagrams, can be implemented by computer-executable instructions. These computer-executable instructions can be provided to a processor of a general-purpose computer, a special-purpose computer, an embedded processor, or another programmable data processing device to produce a machine that, when the instructions are executed by a computer or other programmable data processing device, produces a device that performs the functions specified in one or more flows of the flowcharts or one or more blocks of the block diagrams.

These processor-executable instructions may also be stored in a processor-readable memory that can direct a computer or other programmable data processing device to function in a particular way, such that the instructions stored in the processor-readable memory produce an article of manufacture including instruction means that implement the functions specified in one or more flows of the flowcharts or one or more blocks of the block diagrams.

These processor-executable instructions may also be loaded onto a computer or other programmable data processing device to cause a series of operational steps to be performed on the computer or other programmable device to produce a computer-implemented process such that the instructions executed on the computer or other programmable device provide steps for implementing the functions specified in one or more flows of the flowcharts or one or more blocks of the block diagrams.

Apparently, a person skilled in the art can make various modifications and variations to this disclosure without departing from the spirit and scope of the disclosure. Accordingly, if such modifications and variations of this disclosure fall within the scope of the claims of this disclosure and their equivalents, this disclosure is intended to cover these modifications and variations.

What is claimed is:

1. A method for predicting a target descriptor value of a target object, comprising:
obtaining input information of a trained adversarial neural network, wherein the input information includes N pieces of attribute information to describe the target object, and N is an integer greater than 1; and
running the adversarial neural network to obtain a target predicted value corresponding to a target descriptor of the target object, wherein
the adversarial neural network is an adversarial neural network with i layers, each layer of the adversarial neural network includes a first-level regression neural network and a second-level regression neural network connected in sequence, and i is an integer greater than or equal to 1,
an input of a first-level regression neural network at a first layer of the adversarial neural network is the N pieces of attribute information, and an output of a second-level regression neural network at an i^{th} layer of the adversarial neural network is the target predicted value corresponding to the target descriptor of the target object,
an output of the first-level regression neural network at each layer of the adversarial neural network is an intermediate predicted value corresponding to the target descriptor,
an input of each of a first-level regression neural network at a second layer of the adversarial neural network to a first-level regression neural network at the i^{th} layer of the adversarial neural network is an output of a second-level regression neural network at a previous layer of the adversarial neural network,
an input of a second-level regression neural network at the first layer of the adversarial neural network includes the N pieces of attribute information and an intermediate predicted value output by the first-level regression neural network at the first layer of the adversarial neural network, and
an input of each of a second-level regression neural network at the second layer of the adversarial neural network to the second-level regression neural network at the i^{th} layer of the adversarial neural network includes an intermediate predicted value output by a first-level regression neural network at a corresponding layer and the output of the second-level regression neural network at the previous layer of the adversarial neural network.

2. The method according to claim 1, wherein the first-level regression neural network and the second-level regression neural network are two different regression neural networks.

3. The method according to claim 2, wherein the first-level regression neural network is an artificial neural network (ANN), and the second-level neural network is a convolutional neural network (CNN); or
the first-level regression neural network is a CNN, and the second-level regression neural network is an ANN.

4. The method according to claim 3, wherein when the first-level regression neural network is the ANN, and that the second-level regression neural network is the CNN:
the ANN includes K neuron layers, each neuron layer includes M neurons, and two adjacent neuron layers in the ANN are fully connected; and
the CNN includes P neuron layers, each neuron layer includes Q neurons, and two adjacent neuron layers in the CNN are locally connected based on a preset connection relationship before or during training, wherein
K, M, P, and Q are all integers greater than 1.

5. The method according to claim 4, wherein when the first-level regression neural network at the first layer of the adversarial neural network is the ANN, and that the second-level regression neural network at the first layer of the adversarial neural network is the CNN:
an input of each neuron at a first neuron layer of the first-level regression neural network at the first layer of the adversarial neural network is the N pieces of attribute information, and an output of a last neuron layer of the ANN is the intermediate predicted value of the first-level regression neural network at the first layer of the adversarial neural network; and
an input of a first neuron layer of the second-level regression neural network at the first layer of the adversarial neural network is determined by grouping the intermediate predicted value of the first-level regression neural network at the first layer of the adversarial neural network and the N pieces of attribute information based on a preset grouping relationship.

6. The method according to claim 5, wherein a quantity of input groups obtained based on the preset grouping relationship is Q, and one neuron at a first neuron layer of the P neuron layers corresponds to one input group; and
among the Q input groups, an input group of one neuron at the first neuron layer of the CNN includes the intermediate predicted value of the first-level regression neural network at the first layer of the adversarial neural network, and a total count of times that each of the N pieces of attribute information appears in the Q input groups is the same.

7. The method according to claim 6, wherein N is equal to Q; and
attribute information in each of the Q input groups is randomly obtained from the N pieces of attribute information.

8. The method according to claim 6, wherein a first input group of the Q input groups includes the intermediate predicted value of the first-level regression neural network at the first layer of the adversarial neural network and one piece of attribute information, wherein the first input group is an input group of a first neuron at the first neuron layer of the P neuron layers; and
a quantity of attribute information in other input groups than the first input group among the Q input groups is two pieces.

9. The method according to claim 1, wherein the target object is a target material, and the attribute information is a descriptor.

10. The method according to claim 1, wherein the target object is one of a target material, a target speech, a target text, and a target image.

11. A system for predicting a target descriptor value of a target object, comprising:
at least one storage medium storing at least one set of instructions; and
at least one processor in communication with the at least one storage medium, wherein during operation, the at least one processor executes the at least one set of instructions to cause the system to at least:
obtain input information of a trained adversarial neural network, wherein the input information includes N pieces of attribute information to describe the target object, and N is an integer greater than 1, and
run the adversarial neural network to obtain a target predicted value corresponding to a target descriptor of the target object, wherein
the adversarial neural network is an adversarial neural network with i layers, each layer of the adversarial neural network includes a first-level regression neural network and a second-level regression neural network connected in sequence, and i is an integer greater than or equal to 1,
an input of a first-level regression neural network at a first layer of the adversarial neural network is the N pieces of attribute information, and an output of a second-level regression neural network at an i^{th} layer of the adversarial neural network is the target predicted value corresponding to the target descriptor of the target object,
an output of the first-level regression neural network at each layer of the adversarial neural network is an intermediate predicted value corresponding to the target descriptor,
an input of each of a first-level regression neural network at a second layer of the adversarial neural network to a first-level regression neural network at the i^{th} layer of the adversarial neural network is an output of a second-level regression neural network at a previous layer of the adversarial neural network,
an input of a second-level regression neural network at the first layer of the adversarial neural network includes the N pieces of attribute information and an intermediate predicted value output by the first-level regression neural network at the first layer of the adversarial neural network, and
an input of each of a second-level regression neural network at the second layer of the adversarial neural network to the second-level regression neural network at the i^{th} layer of the adversarial neural network includes an intermediate predicted value output by a first-level regression neural network at a corresponding layer and the output of the second-level regression neural network at the previous layer of the adversarial neural network.

12. The system according to claim 11, wherein the first-level regression neural network and the second-level regression neural network are two different regression neural networks.

13. The system according to claim 12, wherein the first-level regression neural network is an artificial neural network (ANN), and the second-level neural network is a convolutional neural network (CNN); or
the first-level regression neural network is a CNN, and the second-level regression neural network is an ANN.

14. The system according to claim 13, wherein when the first-level regression neural network is the ANN, and that the second-level regression neural network is the CNN:
the ANN includes K neuron layers, each neuron layer includes M neurons, and two adjacent neuron layers in the ANN are fully connected; and
the CNN includes P neuron layers, each neuron layer includes Q neurons, and two adjacent neuron layers in the CNN are locally connected based on a preset connection relationship before or during training, wherein
K, M, P, and Q are all integers greater than 1.

15. The system according to claim 14, wherein when the first-level regression neural network at the first layer of the adversarial neural network is the ANN, and that the second-level regression neural network at the first layer of the adversarial neural network is the CNN:
an input of each neuron at a first neuron layer of the first-level regression neural network at the first layer of the adversarial neural network is the N pieces of attribute information, and an output of a last neuron layer of the ANN is the intermediate predicted value of the first-level regression neural network at the first layer of the adversarial neural network; and
an input of a first neuron layer of the second-level regression neural network at the first layer of the adversarial neural network is determined by grouping the intermediate predicted value of the first-level regression neural network at the first layer of the adversarial neural network and the N pieces of attribute information based on a preset grouping relationship.

16. The system according to claim 15, wherein a quantity of input groups obtained based on the preset grouping relationship is Q, and one neuron at a first neuron layer of the P neuron layers corresponds to one input group; and
among the Q input groups, an input group of one neuron at the first neuron layer of the CNN includes the intermediate predicted value of the first-level regression neural network at the first layer of the adversarial neural network, and a total count of times that each of the N pieces of attribute information appears in the Q input groups is the same.

17. The system according to claim 16, wherein N is equal to Q; and
attribute information in each of the Q input groups is randomly obtained from the N pieces of attribute information.

18. The system according to claim 16, wherein a first input group of the Q input groups includes the intermediate predicted value of the first-level regression neural network at the first layer of the adversarial neural network and one piece of attribute information, wherein the first input group is an input group of a first neuron at the first neuron layer of the P neuron layers; and
a quantity of attribute information in other input groups than the first input group among the Q input groups is two pieces.

19. The system according to claim 11, wherein the target object is a target material, and the attribute information is a descriptor.

20. The system according to claim 11, wherein the target object is one of a target material, a target speech, a target text, and a target image.
